(19) United States
(12) Patent Application Publication
(10) Pub. No.: US 2024/0212888 A1
(43) Pub. Date: Jun. 27, 2024

(54) CHIP RESISTOR MODULE

(71) Applicant: ROHM CO., LTD., Kyoto-shi (JP)

(72) Inventor: Masahiro UCHIDA, Kyoto-shi (JP)

(21) Appl. No.: 18/598,969

(22) Filed: Mar. 7, 2024

Related U.S. Application Data
(63) Continuation of application No. PCT/JP22/32394, filed on Aug. 29, 2022.

(30) Foreign Application Priority Data
Nov. 18, 2021 (JP) 2021-187678

(51) Int. Cl. H01C 1/142; H01C 1/028; H01C 17/00

(52) U.S. Cl. CPC H01C 1/142; H01C 1/028; H01C 17/006

(57) ABSTRACT

A chip resistor module includes a wiring board, a plurality of chip resistors, and a pair of terminal electrodes. The wiring board includes an insulating substrate and an electrical wire provided on the insulating substrate. The plurality of chip resistors are bonded to the electrical wire. The pair of terminal electrodes is electrically connected to the electrical wire.

### TECHNICAL FIELD

The present disclosure relates to a chip resistor module.

### BACKGROUND ART

Japanese Patent Laying-Open No. 2021-36557 (PTL 1) discloses a resistor including a resistive element main body, a casing where the resistive element main body is accommodated, and a cement material as a sealing material. The resistive element main body accommodated in the casing is sealed with the cement material. The resistive element main body includes a resistive element, a pair of caps, and a pair of terminal plates. The resistive element includes an insulator in a columnar shape and a resistive wire wound around an outer peripheral surface of the insulator. The pair of caps is made of metal and covers opposing ends of the insulator. The pair of terminal plates is made of metal and provided at opposing ends of the insulator with the pair of caps being interposed. The pair of terminal plates protrudes from the casing and the cement material, and is mounted on a circuit board.

### CITATION LIST

### Patent Literature

PTL 1: Japanese Patent Laying-Open No. 2021-36557

### SUMMARY

The resistor in PTL 1, however, had to manually be mounted on the circuit board. In addition, when a plurality of resistors in PTL 1 rather than a single resistor should be used for specifications required by a user, electric power more than necessary is inevitably used because rated power per one resistor is great. Individual modifications to the specifications (for example, a resistance value, rated power, or the like) of the resistor in accordance with an application of the resistor necessitates design of a diameter or the number of turns of the resistive wire each time, which results in low general applicability. Thus, usability of the resistor in PTL 1 is low for the user of the resistor. The present disclosure was made in view of the problem above, and an object thereof is to provide a chip resistor module that achieves improved usability for a user and reduction in cost.

A chip resistor module in the present disclosure includes a wiring board, a plurality of chip resistors, and a pair of terminal electrodes. The wiring board includes an insulating substrate and an electrical wire provided on the insulating substrate. The plurality of chip resistors are bonded to the electrical wire. The pair of terminal electrodes is electrically connected to the electrical wire.

### BRIEF DESCRIPTION OF DRAWINGS

FIG. 1 is a schematic plan view of a chip resistor module in an embodiment.

FIG. 2 is a schematic cross-sectional view of the chip resistor module in the embodiment along the line II-II shown in FIG. 1.

FIG. 3 is an enlarged schematic plan view of a chip resistor included in the chip resistor module in the embodiment.

FIG. 4 is an enlarged schematic cross-sectional view of the chip resistor included in the chip resistor module in the embodiment along the line IV-IV shown in FIG. 3.

FIG. 5 is a schematic cross-sectional view showing one step in a method of manufacturing the chip resistor module in the embodiment.

FIG. 6 is a schematic cross-sectional view showing a step next to the step shown in FIG. 5, in the method of manufacturing the chip resistor module in the embodiment.

FIG. 7 is a schematic cross-sectional view showing a step next to the step shown in FIG. 6, in the method of manufacturing the chip resistor module in the embodiment.

FIG. 8 is a schematic cross-sectional view of the chip resistor module in a first modification of the embodiment.

FIG. 9 is a schematic plan view of the chip resistor module in a second modification of the embodiment.

### DETAILED DESCRIPTION

Details of an embodiment of the present disclosure will be described with reference to the drawings. The same or corresponding elements in the drawings below have the same reference characters allotted and description thereof will not be repeated. Features in at least a part of the embodiment which will be described below may freely be combined.

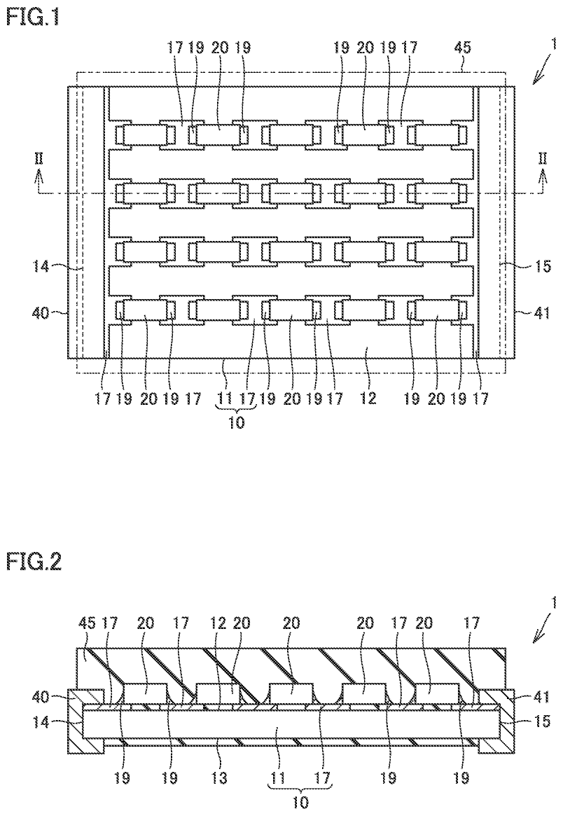

A chip resistor module 1 in an embodiment will be described with reference to FIGS. 1 and 2. Chip resistor module 1 includes a wiring board 10, a plurality of chip resistors 20, and a pair of terminal electrodes 40 and 41. Chip resistor module 1 may further include an insulating sealing member 45.

Wiring board 10 is, for example, a printed circuit board. Wiring board 10 includes an insulating substrate 11 and an electrical wire 17.

Insulating substrate 11 is formed of an electrically insulating material. Insulating substrate 11 is, for example, a glass epoxy substrate or a ceramic substrate (for example, an alumina substrate). Insulating substrate 11 is provided with a front surface 12, a back surface 13, and side surfaces 14 and 15. Each of side surfaces 14 and 15 is connected to front surface 12 and back surface 13. Side surface 15 may be on a side opposite to side surface 14. A longitudinal direction of insulating substrate 11 may be a direction in which side surface 14 and side surface 15 are separated from each other.

Electrical wire 17 is formed, for example, of metal such as copper or aluminum. Electrical wire 17 is provided on insulating substrate 11 (for example, front surface 12). Electrical wire 17 is formed, for example, by patterning a conductive film provided on the entire front surface 12 by etching or the like.

The plurality of chip resistors 20 are bonded to electrical wire 17 with the use of a conductive bonding member 19 such as solder. In a plan view of front surface 12 of insulating substrate 11, the plurality of chip resistors 20 are two-dimensionally aligned. In the plan view of front surface 12 of insulating substrate 11, the plurality of chip resistors 20 are aligned along the longitudinal direction of insulating substrate 11 and a direction of a short side of insulating substrate 11. The plurality of chip resistors 20 may be connected to one another in series, in parallel, or in series-parallel.

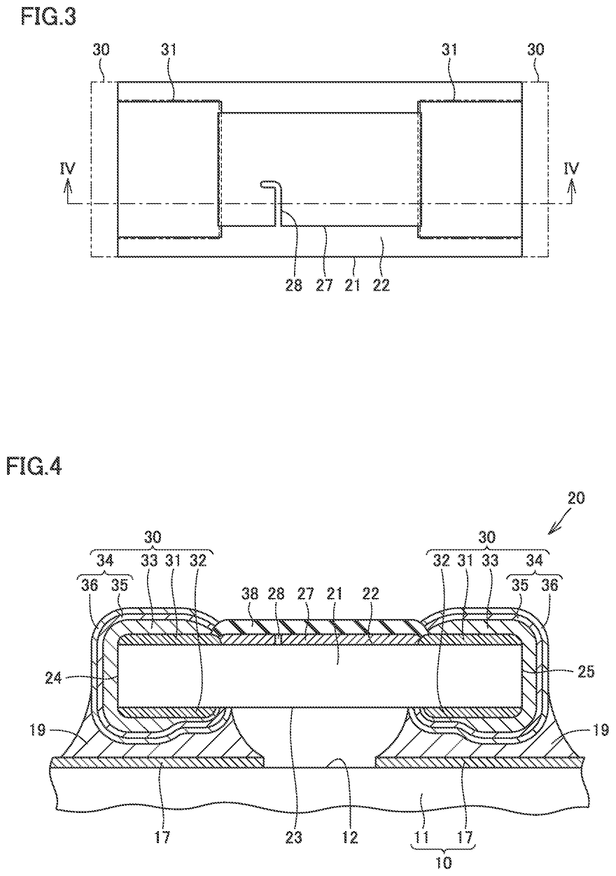

Referring to FIGS. 3 and 4, each of the plurality of chip resistors 20 includes an insulating substrate 21, a pair of electrodes 30, and a resistive element 27. Each of the plurality of chip resistors 20 may further include an insulating protective layer 38.

Insulating substrate 21 is an electrical insulator and formed of an electrically insulating material such as alumina (Al₂O₃). Insulating substrate 21 includes a first main surface 22, a second main surface 23 opposite to first main surface 22, a side surface 24, and a side surface 25 opposite to side surface 24. Side surface 24 and side surface 25 are each connected to first main surface 22 and second main surface 23. The longitudinal direction of insulating substrate 21 is a direction in which side surface 24 and side surface 25 are separated from each other. Second main surface 23 may face insulating substrate 11 (for example, front surface 12).

Resistive element 27 performs a function to restrict a current or a function to detect a current. Resistive element 27 is provided, for example, on first main surface 22 of insulating substrate 21. Resistive element 27 is formed, for example, by printing a paste obtained by incorporating glass frit in an electrically resistive material such as ruthenium oxide (RuO₂) or a silver-palladium alloy onto first main surface 22 of insulating substrate 21 and firing the paste. Resistive element 27 is provided with a trimming groove 28. Provision of trimming groove 28 in resistive element 27 can allow accurate determination of a resistance value of each of the plurality of chip resistors 20.

One of the pair of electrodes 30 is provided on a side of side surface 24 of insulating substrate 21. One of the pair of electrodes 30 is more proximal to side surface 24 than side surface 25. The other of the pair of electrodes 30 is provided on the side of side surface 25 of insulating substrate 21. The other of the pair of electrodes 30 is more proximal to side surface 25 than side surface 24. Each of the pair of electrodes 30 includes, for example, a front surface electrode 31, a back surface electrode 32, a side surface electrode 33, and a metallic plated layer 34.

Front surface electrode 31 is provided on first main surface 22. Front surface electrode 31 is in contact with resistive element 27. Front surface electrode 31 is formed, for example, by printing a paste containing silver onto first main surface 22 of insulating substrate 21 and firing the paste. Back surface electrode 32 is provided on second main surface 23. Back surface electrode 32 is formed, for example, by printing a paste containing silver onto second main surface 23 of insulating substrate 21 and firing the paste.

Side surface electrode 33 is provided on side surfaces 24 and 25, front surface electrode 31, and back surface electrode 32. Side surface electrode 33 is electrically connected to front surface electrode 31 and back surface electrode 32. Side surface electrode 33 is formed by applying a paste containing metallic particles such as silver particles and resin such as an epoxy resin onto side surfaces 24 and 25, front surface electrode 31, and back surface electrode 32.

Metallic plated layer 34 is provided on front surface electrode 31, back surface electrode 32, and side surface electrode 33. Metallic plated layer 34 includes, for example, an inner plated layer 35 and an outer plated layer 36. Inner plated layer 35 is formed on side surface electrode 33 to cover side surface electrode 33. Inner plated layer 35 protects front surface electrode 31, back surface electrode 32, and side surface electrode 33 against heat and impact. Inner plated layer 35 is, for example, a nickel plated layer. Outer plated layer 36 is formed on inner plated layer 35 to cover inner plated layer 35. Outer plated layer 36 is formed of a material to which conductive bonding member 19 such as solder is more readily attached than to inner plated layer 35. Outer plated layer 36 is, for example, a tin plated layer. Conductive bonding member 19 is attached to outer plated layer 36 and electrical wire 17 of wiring board 10, so that chip resistor 20 is mounted on wiring board 10.

Insulating protective layer 38 is provided on resistive element 27. Insulating protective layer 38 electrically isolates the pair of electrodes 30 from each other. Insulating protective layer 38 is formed of an insulating resin such as an epoxy resin. Insulating protective layer 38 is formed, for example, by printing and curing a paste containing the insulating resin.

Referring to FIGS. 1 and 2, the plurality of chip resistors 20 are sealed with insulating sealing member 45. Insulating sealing member 45 covers the plurality of chip resistors 20, front surface 12 of insulating substrate 11, and electrical wire 17. Insulating sealing member 45 is formed, for example, of an electrically insulating resin such as an epoxy resin. Insulating sealing member 45 protects the plurality of chip resistors 20 against moisture or the like contained in an ambient atmosphere around chip resistor module 1. Insulating sealing member 45 may further cover back surface 13 of insulating substrate 11 and a part of each of the pair of terminal electrodes 40 and 41. Insulating sealing member 45 may be in contact with each of the pair of terminal electrodes 40 and 41.

The pair of terminal electrodes 40 and 41 is electrically connected to electrical wire 17. Terminal electrode 40 is provided on electrical wire 17, side surface 14 of insulating substrate 11, and back surface 13 of insulating substrate 11. Terminal electrode 41 is provided on electrical wire 17, side surface 15 of insulating substrate 11, and back surface 13 of insulating substrate 11. Terminal electrodes 40 and 41 are formed of a conductive material such as copper, aluminum, or silver. Terminal electrodes 40 and 41 may be, for example, a lead frame formed of metal such as copper or aluminum. Terminal electrodes 40 and 41 may be formed, for example, by applying a conductive paste containing metallic particles such as silver particles onto electrical wire 17, side surfaces 14 and 15 of insulating substrate 11, and back surface 13 of insulating substrate 11. At least a part of each of terminal electrodes 40 and 41 is exposed from insulating sealing member 45. A surface of each of terminal electrodes 40 and 41 may be covered with a layer (for example, a tin layer) formed of a material to which a conductive bonding member such as solder is readily attached.

Chip resistor module 1 is, for example, a discharging resistor. The discharging resistor is connected in parallel to a capacitor (not shown). The discharging resistor discharges, in a short period of time, a voltage charged to the capacitor. The discharging resistor is used, for example, in a charging and discharging circuit for an electric vehicle or the like. In an example where the discharging resistor is continuously fed with a current, the discharging resistor has rated power, for example, of 5 W or higher. In an example where the discharging resistor is instantaneously fed with a current over a time period of ten seconds or shorter, the discharging resistor has rated power, for example, of 20 W or higher. Rated power herein means an upper limit of electric power that the discharging resistor (chip resistor module 1) can consume without the plurality of chip resistors 20 being burnt.

An exemplary method of manufacturing chip resistor module 1 in the present embodiment will be described with reference to FIGS. 1, 2, and 5 to 7.

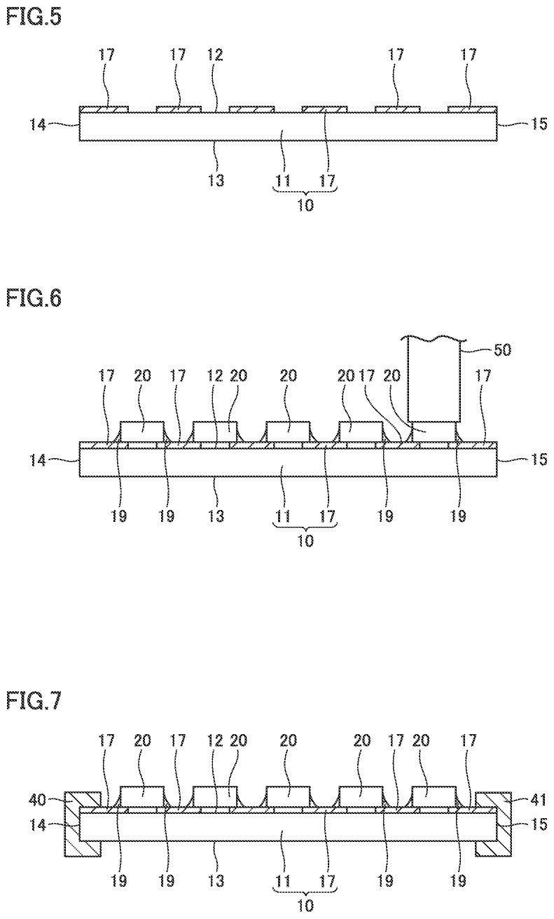

Referring to FIG. 5, wiring board 10 is prepared by forming electrical wire 17 on insulating substrate 11. Electrical wire 17 in a pattern suitable for an application of chip resistor module 1 is formed, for example, by patterning of a conductive film on insulating substrate 11 by etching or the like. Referring to FIG. 6, a die bonder 50 is used to bond the plurality of chip resistors 20 to electrical wire 17. The plurality of chip resistors 20 are bonded to electrical wire 17 with the use of conductive bonding member 19.

Referring to FIG. 7, the pair of terminal electrodes 40 and 41 that is electrically connected to electrical wire 17 is provided. In an example, a lead frame as the pair of terminal electrodes 40 and 41 may be bonded to electrical wire 17 with the use of conductive bonding member 19 (not shown) such as solder. In another example, the pair of terminal electrodes 40 and 41 may be formed by applying a conductive paste containing metallic particles such as silver particles onto electrical wire 17, side surfaces 14 and 15, and back surface 13. Referring to FIGS. 1 and 2, insulating sealing member 45 with which the plurality of chip resistors 20 are sealed is provided by compression molding or transfer molding. Chip resistor module 1 is thus obtained.

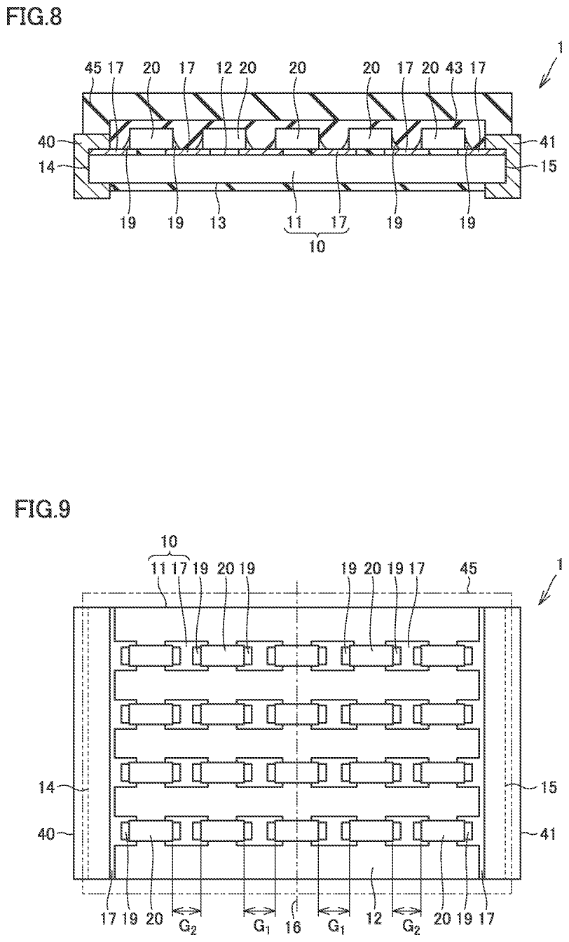

Referring to FIG. 8, chip resistor module 1 in a first modification of the present embodiment further includes a thermally conductive sheet 43. Thermally conductive sheet 43 is higher in thermal conductivity than insulating sealing member 45. Thermally conductive sheet 43 has a thermal conductivity, for example, of 0.5 W/(m·K) or higher. Thermally conductive sheet 43 may have a thermal conductivity of 1.0 W/(m·K) or higher, a thermal conductivity of 3.0 W/(m·K) or higher, or a thermal conductivity of 5.0 W/(m·K) or higher. Thermally conductive sheet 43 is formed, for example, of a silicone-based resin. Thermally conductive sheet 43 covers the plurality of chip resistors 20 and is electrically insulating. Thermally conductive sheet 43 may be in contact with electrical wire 17. Thermally conductive sheet 43 may be in contact with the pair of terminal electrodes 40 and 41. Thermally conductive sheet 43 is arranged between the plurality of chip resistors 20 and insulating sealing member 45. Insulating sealing member 45 covers thermally conductive sheet 43.

Referring to FIG. 9, in chip resistor module 1 in a second modification of the present embodiment, in a direction in which the pair of terminal electrodes 40 and 41 is separated from each other (a lateral direction in FIG. 9), an interval between each pair of adjacent chip resistors 20 among the plurality of chip resistors 20 is greater toward a center 16 of insulating substrate 11. Specifically, an interval G₁ is an interval between a pair of first chip resistors adjacent to each other among the plurality of chip resistors 20 in the direction in which the pair of terminal electrodes 40 and 41 is separated from each other. An interval G₂ is an interval between a pair of second chip resistors adjacent to each other among the plurality of chip resistors 20 in the direction in which the pair of terminal electrodes 40 and 41 is separated from each other. In the direction in which the pair of terminal electrodes 40 and 41 is separated from each other, the pair of first chip resistors is arranged closer to center 16 of insulating substrate 11 than the pair of second chip resistors. Interval G₁ is greater than interval G₂.

Effects of chip resistor module 1 in the present embodiment will be described.

Chip resistor module 1 in the present embodiment includes wiring board 10, the plurality of chip resistors 20, and the pair of terminal electrodes 40 and 41. Wiring board 10 includes insulating substrate 11 and electrical wire 17 provided on insulating substrate 11. The plurality of chip resistors 20 are bonded to electrical wire 17. The pair of terminal electrodes 40 and 41 is electrically connected to electrical wire 17.

In chip resistor module 1, the plurality of chip resistors 20, wiring board 10, and the pair of terminal electrodes 40 and 41 are modularized. Therefore, chip resistor module 1 can be mounted on a circuit board (not shown) with the use of a mounter (not shown). In addition, chip resistor module 1 having specifications (for example, a resistance value, rated power, or the like) suitable for an application of chip resistor module 1 can readily be obtained by changing the number of chip resistors 20 or the pattern of electrical wire 17. Chip resistor module 1 improved in usability for a user can thus be provided.

Chip resistor module 1 is obtained by a simpler step of attaching the plurality of chip resistors 20 and the pair of terminal electrodes 40 and 41 to wiring board 10. Chip resistor module 1 can be assembled with the use of a machine such as die bonder 50. Cost for chip resistor module 1 can be reduced.

Furthermore, the plurality of chip resistors 20 can be arranged on wiring board 10 as being integrated, and therefore chip resistor module 1 can be reduced in size.

In chip resistor module 1 in the present embodiment, an interval between each pair of adjacent chip resistors 20 among the plurality of chip resistors 20 is greater toward center 16 of insulating substrate 11 in a direction in which the pair of terminal electrodes 40 and 41 is separated from each other.

Center 16 of insulating substrate 11 is a portion of insulating substrate 11 most separated from the pair of terminal electrodes 40 and 41. Therefore, a temperature of chip resistors 20 tends to increase toward center 16 of insulating substrate 11. According to chip resistor module 1 in the present embodiment, however, increase in temperature of chip resistors 20 located near center 16 of insulating substrate 11 can be suppressed. Therefore, rated power of chip resistor module 1 can be increased. Lifetime of chip resistor module 1 can be longer. Chip resistor module 1 improved in usability for the user can be provided.

Chip resistor module 1 in the present embodiment further includes insulating sealing member 45 with which the plurality of chip resistors 20 are sealed.

Insulating sealing member 45 protects the plurality of chip resistors 20 against moisture or the like contained in the ambient atmosphere around chip resistor module 1. Therefore, lifetime of chip resistor module 1 can be longer. Chip resistor module 1 improved in usability for the user can be provided.

Chip resistor module 1 in the present embodiment further includes thermally conductive sheet 43. Thermally conductive sheet 43 covers the plurality of chip resistors 20 and is electrically insulating.

Thermally conductive sheet 43 quickly spreads heat generated in the plurality of chip resistors 20 to allow efficient emission of this heat to the outside of chip resistor module 1 through the pair of terminal electrodes 40 and 41. Increase in temperature of the plurality of chip resistors 20 can be suppressed. Therefore, rated power of chip resistor module 1 can be increased. Lifetime of chip resistor module 1 can be longer. Chip resistor module 1 can be reduced in size. Chip resistor module 1 improved in usability for the user can be provided.

In chip resistor module 1 in the present embodiment, thermally conductive sheet 43 is in contact with the pair of terminal electrodes 40 and 41.

Thermally conductive sheet 43 quickly conducts heat generated in the plurality of chip resistors 20 to the pair of terminal electrodes 40 and 41 to allow efficient emission of heat to the outside of chip resistor module 1 through the pair of terminal electrodes 40 and 41. Therefore, rated power of chip resistor module 1 can be increased. Lifetime of chip resistor module 1 can be longer. Chip resistor module 1 can be reduced in size. Chip resistor module 1 improved in usability for the user can be provided.

In chip resistor module 1 in the present embodiment, insulating substrate 11 is provided with front surface 12, back surface 13, and side surfaces 14 and 15 connected to front surface 12 and back surface 13. Electrical wire 17 is formed on front surface 12. The pair of terminal electrodes 40 and 41 is provided on electrical wire 17, side surfaces 14 and 15, and back surface 13.

Therefore, chip resistor module 1 can be mounted on a circuit board (not shown) with the use of a mounter (not shown). Chip resistor module 1 improved in usability for the user can be provided.

In chip resistor module 1 in the present embodiment, insulating substrate 11 is provided with front surface 12. Electrical wire 17 is formed on front surface 12. In the plan view of front surface 12, the plurality of chip resistors 20 are two-dimensionally aligned.

Therefore, chip resistor module 1 can be reduced in size. Chip resistor module 1 improved in usability for the user can be provided.

Chip resistor module 1 in the present embodiment is a discharging resistor.

The discharging resistor improved in usability for the user can be provided. Cost for the discharging resistor can be reduced. The discharging resistor can be reduced in size.

It should be understood that the embodiments and the modifications thereof disclosed herein are illustrative and non-restrictive in every respect. The scope of the present disclosure is defined by the terms of the claims rather than the description above and is intended to include any modifications within the scope and meaning equivalent to the terms of the claims.

### REFERENCE SIGNS LIST

1 chip resistor module; 10 wiring board; 11 insulating substrate; 12 front surface; 13 back surface; 14, 15 side surface; 16 center; 17 electrical wire; 19 conductive bonding member; 20 chip resistor; 21 insulating substrate; 22 first main surface; 23 second main surface; 24, 25 side surface; 27 resistive element; 28 trimming groove; 30 electrode; 31 front surface electrode; 32 back surface electrode; 33 side surface electrode; 34 metallic plated layer; 35 inner plated layer; 36 outer plated layer; 38 insulating protective layer; 40, 41 terminal electrode; 43 thermally conductive sheet; 45 insulating sealing member; 50 die bonder

1. A chip resistor module comprising:
a wiring board;
a plurality of chip resistors; and
a pair of terminal electrodes, wherein
the wiring board includes an insulating substrate and an electrical wire provided on the insulating substrate,
the plurality of chip resistors are bonded to the electrical wire, and
the pair of terminal electrodes is electrically connected to the electrical wire.

2. The chip resistor module according to claim 1, wherein
in a direction in which the pair of terminal electrodes is separated from each other, an interval between each pair of adjacent chip resistors among the plurality of chip resistors is greater toward a center of the insulating substrate.

3. The chip resistor module according to claim 1, further comprising an insulating sealing member with which the plurality of chip resistors are sealed.

4. The chip resistor module according to claim 3, further comprising a thermally conductive sheet higher in thermal conductivity than the insulating sealing member, wherein
the thermally conductive sheet covers the plurality of chip resistors and is electrically insulating.

5. The chip resistor module according to claim 4, wherein
the thermally conductive sheet is in contact with the pair of terminal electrodes.

6. The chip resistor module according to claim 1, wherein
the insulating substrate is provided with a front surface, a back surface, and a side surface connected to the front surface and the back surface,
the electrical wire is formed on the front surface, and
the pair of terminal electrodes is provided on the electrical wire, the side surface, and the back surface.

7. The chip resistor module according to claim 1, wherein
the insulating substrate is provided with a front surface,
the electrical wire is formed on the front surface, and
in a plan view of the front surface, the plurality of chip resistors are two-dimensionally aligned.

8. The chip resistor module according to claim 1, the chip resistor module being a discharging resistor.
